(19) United States
(12) Patent Application Publication
(10) Pub. No.: US 2007/0024433 A1
(43) Pub. Date: Feb. 1, 2007

(54) Multiple independent mode pedestrian collision avoidance warning system

(76) Inventor: Michael Lynn Garner, Gray, TN (US)

Correspondence Address: Michael L. Garner, 122 Hillrise Road, Gray, TN, 37615, US

(21) Appl. No.: 11/495,940

(22) Filed: Jul. 28, 2006

Related U.S. Application Data
(60) Provisional application No. 60/703,483, filed on Jul. 28, 2005.

(51) Int. Cl. B60Q 1/00; G08G 1/00

(52) U.S. Cl. 340/436; 340/901

(57) ABSTRACT

A pedestrian warning system, utilizing specifically place infrared motion detectors, specifically placed visual and audible warning devices, controlled by a multiple independent mode system circuitry and all operating on low voltage direct current, for giving advance visual and audible warnings to pedestrians and/or individuals operating equipment in dose proximity to pedestrians to prevent and avoid collisions between said individuals at or around areas of limited vision where said traffic may meet or intersect such as hallways, corridors, rampways, and any other various said traffic lanes within and/or outside building structures.

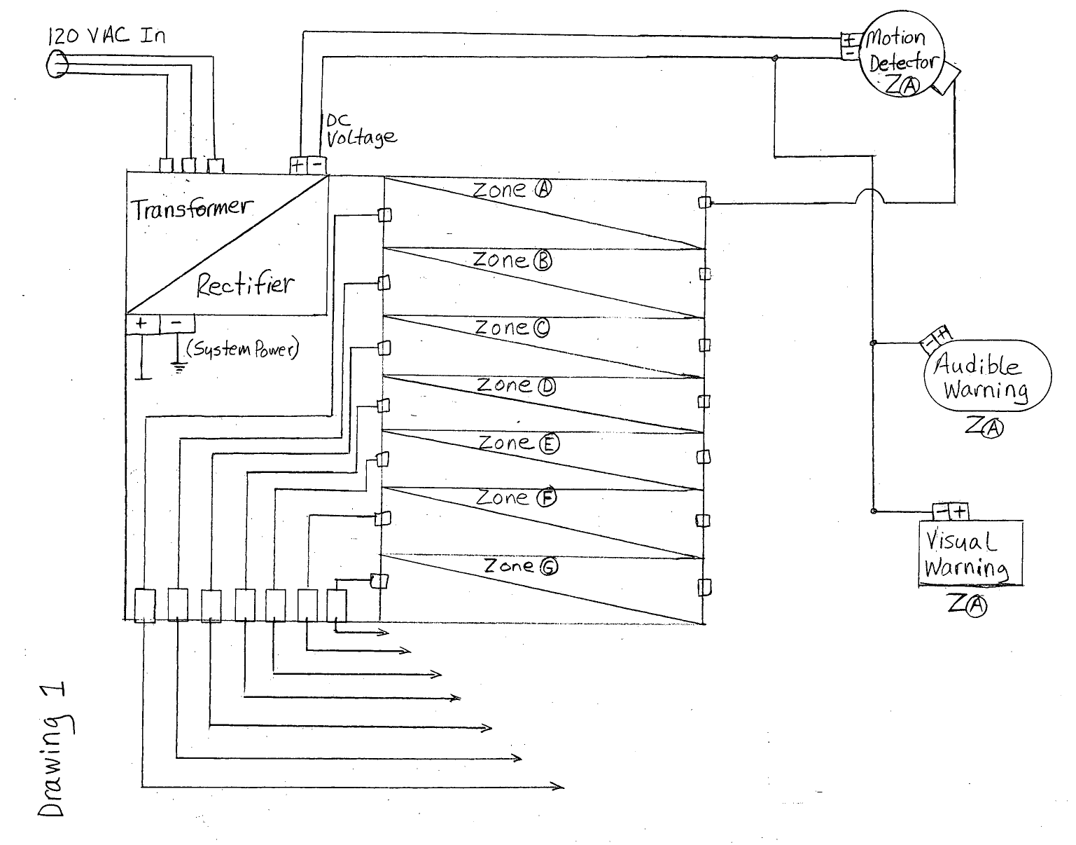

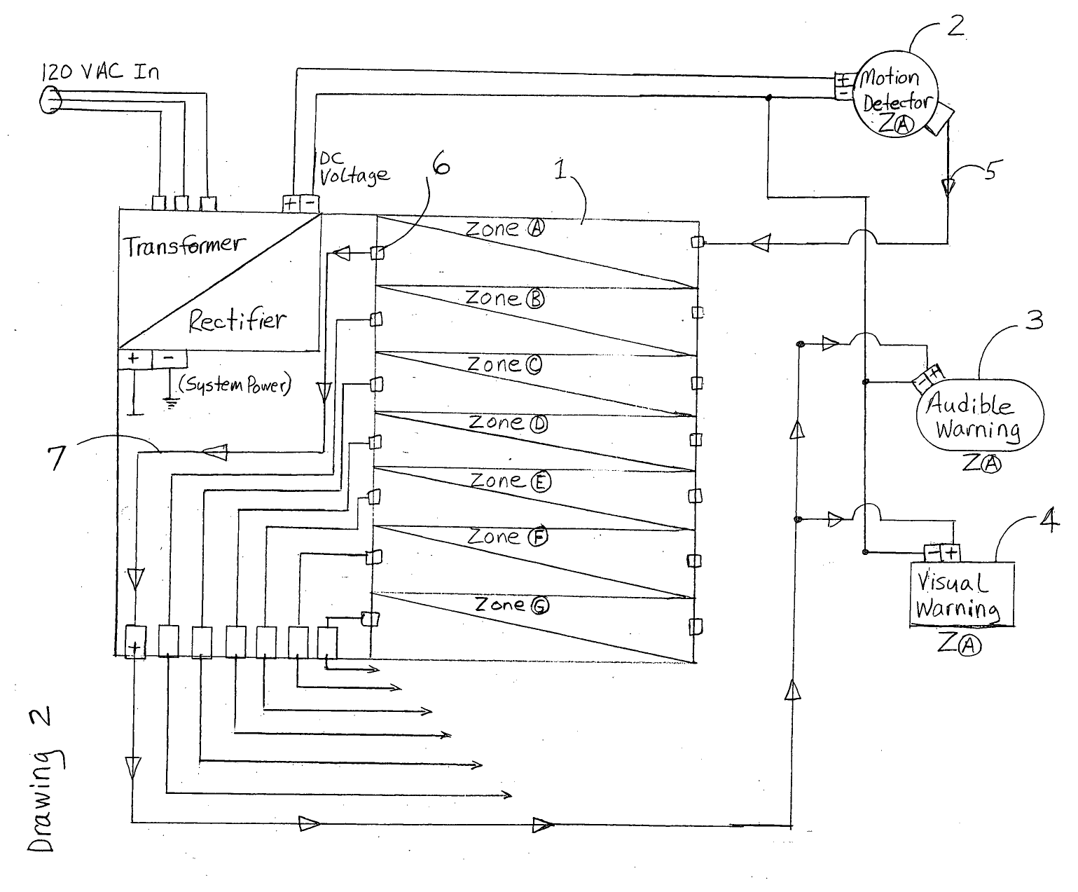

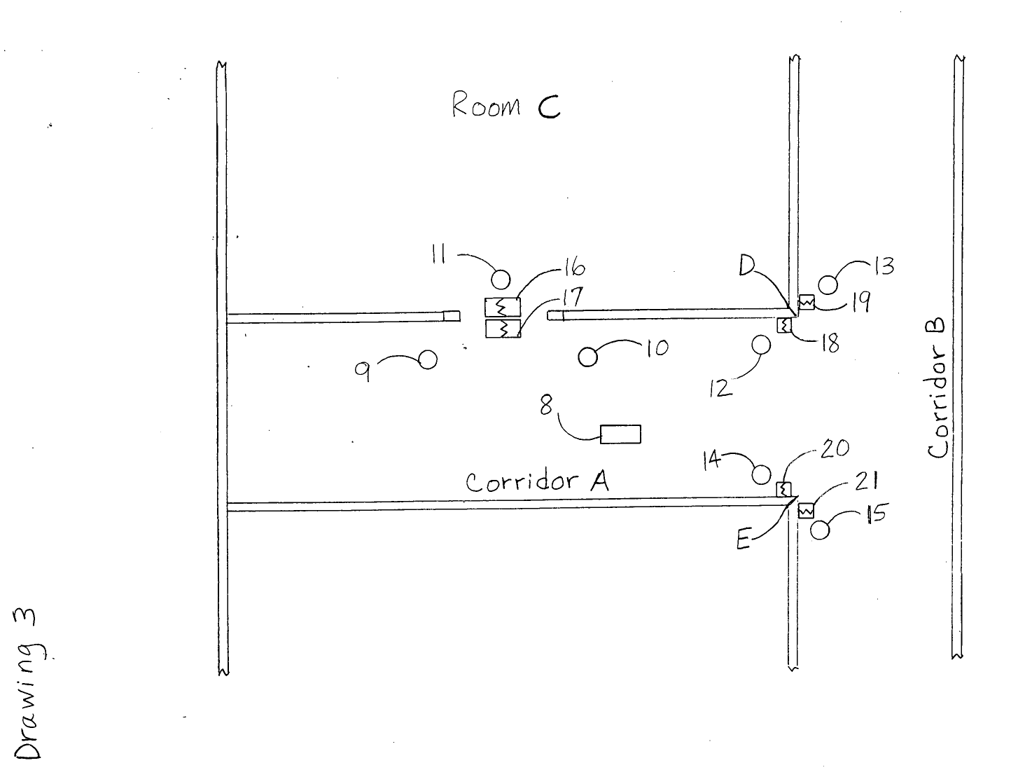

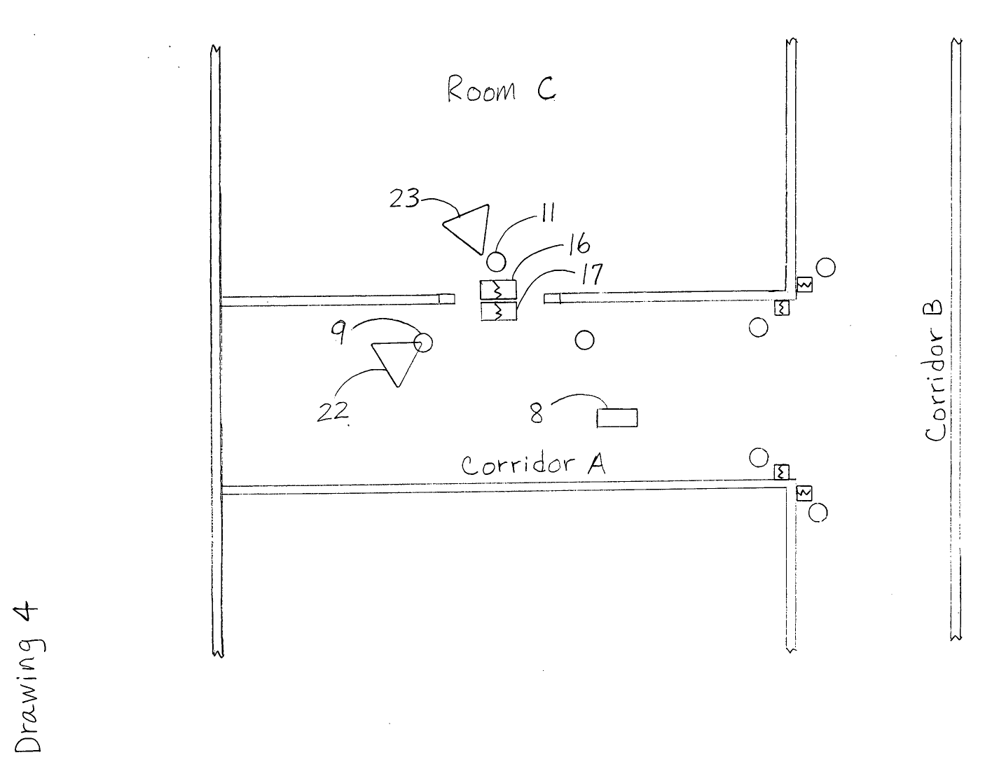

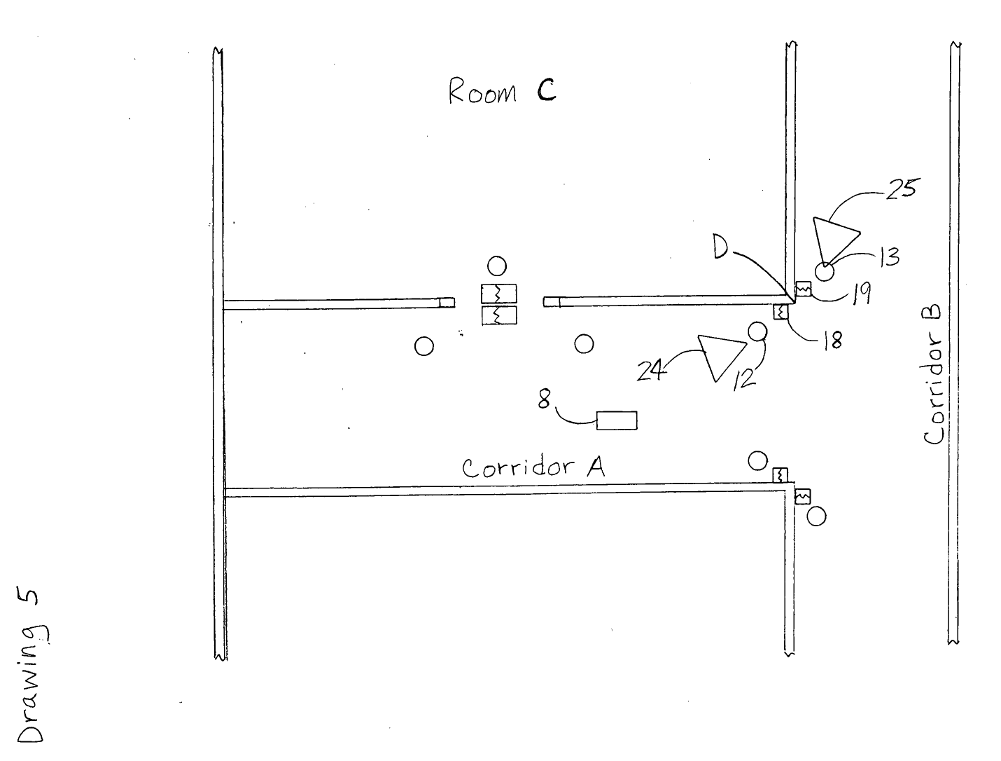

### CROSS-REFERRENCED TO RELATED APPLICATIONS

I claim priority under 35 U.S.C. .sctn. 119(e) to U.S. Provisional Application No. 60/703,483 dated Jul. 28, 2005, Titled, Multiple Independent Mode Interior Pedestrian Collision Avoidance System, the disclosure of which is expressly incorporated by reference herein in its entirety.

### STATEMENT REGARDING FEDERALLY SPONSORED RESEARCH OR DEVELOPMENT

None.

### BACKGROUND OF INVENTION

Pertaining to building structures having corridors, hallways, stairwells, aisleways, traffic lanes, doorways, elevators, and rampways, herein referred to as accessways, for directing movement of people and/or equipment operated by people during daily business operatioins. More particularly pertaining to corners formed by said accessways intersecting one another forming outwardly extending corners creating common blind spot areas to pedestrian traffic and/or equipment traffic opertated by people as said traffic meet at these corners creating possible dangerous conflict zones. These said conflict zones can occur within or outside office buildings, restaurants, hospitals, parking garages, warehouses, and airport terminals.

The object of this invention is to present a unique warning system that can monitor multiple pedestrian traffic hazzard zones and/or equipment operated by individuals at said zones, independently and provide visual and audible warnings independently for each established hazzard zone monitored and controled by an adjacent remote system contoller for giving advance warnings to said pedestrians and/or said individuals operating equipment to prevent possible collisions at said conflict zones within and/or outside of building structures.

### SUMMARY OF PRIOR ART

I have found no prior art claiming warning systems capable of monitoring multiple areas of pedestrian traffic conflict by corrisponding multiple independent sensors, each having its own individual visual and audible warning devices for each area of conflict and controled by a single central adjacent controller for multiple independent monitoring of said conflict areas without need for additional devices worn by individuals or affixed to equipment for operation.

### SUMMARY OF INVENTION

A pedestrian collision avoidance warning system capable of monitoring and warning multiple areas of pedestrian traffic conflict where collisions with opposing pedestrians and/or pedestrians colliding with opposing equipment operated by people as said meet or conflict with one another at corners formed by accessways intersecting causing natural limitations in peoples lines of sight. This warning system, by utilizing multiple independent infrared motion sensors with each sensor activating its own corresponding visual and audible warning device(s), either ajoined with or remotely located from said corresponding sensor, all controlled by a centrally located multiple independent mode system controller, will provide advance warnings to pedestrians and/or equipment operaters to prevent possible collision events between said groups requiring no special mirrors, reflectors, transmitters, recievers, antennas, or any other devices to be worn or attached to said groups to facilitate operation.

### BRIEF DESCRIPTION OF DRAWINGS

Drawing 1 shows a simple view of a block diagram of circuit for the system control module having an internal D.C. power supply.

Drawing 1 also depicts a motion detector, audible warning, and visual warning devices connected to zone A circuit of the block diagram.

Drawing 2 shows same block diagram circuit as Drawing 1 with zone A in operation and corresponding to its sensor and warning devices.

Drawing 3 depicts corridor A intersecting corridor B forming corners D and E with an open doorway between corridor A and room C.

Drawing 3 also depicts warning system with control module 8 in ceiling of corridor A, motion detectors 9 thru 15 mounted on ceilings with visual/audible warning devices 16 and 17 above doorway and warning devices 18 thru 21 on walls above eye level for corners D and E.

Drawing 4 depicts operation as pedestrian 22 entering through a doorway into room C at the same approximate time pedestrian 23 is exiting room C into corridor A.

Drawing 5 depicts operation as pedestrian 25 is about to round corner D just before meeting opposing pedestrian 24.

### DETAILED DESCRIPTION OF EMBODIMENT

Drawing 1, shows block diagram of electronic control module showing a transformer with rectifier for regulated low voltage DC system power from a 120 volt AC source. Diagram depicts a multiple monitoring module, zones A thru G, each zone controlling a specific monitored pedestrian traffic area. Each zone controls at least, one motion detector, one visual warning device, and one audible warning device (audible warning is optional) allowing each zone to operate as independent modes which allows one system controller to monitor multiple pedestrian traffic areas and emit warnings individually to a specific zone and/or all zones the same time when and if all detectors are activated simultaneously.

Drawing 2, shows same block diagram in Drawing 1, depicting normal operation with system powered by regulated low voltage DC and all circuits grounded through the control module. Zone 1 is being monitored by motion detector 2, audible warning 3 and visual warning 4 therefore when motion detector 2 is actuated response signal 5 is relayed to monitor zone 1 which processes input signal 5 to signal output 6 of zone A which initiates a internal flasher output signal 7 to the positive lead for audible warning 3 and visual warning 4 actuating both warning devices until timed output signal 5 ceases activation through detector 2's own timed activation then system instantly resets and zone A is ready for another signal input from motion detector 2 of zone A. The electronic control module will perform this same said function in all monitoring zones, individually and/or all at the same moment if all specially placed motion detectors actuates the system to respond.

Drawing 3, depicts corridor A intersecting corridor B and room C off of corridor A with entry/exit doorway without a door closure. System control module 8 is mounted within false ceiling above corridor A (module 8 could also be mounted on ceiling if no false ceiling exists or on wall close to ceiling) with motion detectors 9 thru 15 placed at strategic points on the ceiling above at their respective conflict areas. Visual warning and audible warning combination devices 16 and 17 mounted above doorway exiting and entering room C respectively. Visual and audible warning combination devices 18 thru 21 are placed perpendicularly from the ceilings down the walls on the corners formed by the intersection or corridors A and B. Said devices 18 thru 21 are placed just above eye level (placement height can vary) for easy viewing by pedestrians. System is in place and functioning as a multiple warning zone system for illustration purposes.

Drawing 4, depicts pedestrian 22 walking along corridor A approaching doorway to enter room C while pedestrian 23 is about to exit room C into corridor A at approximately the same time. Pedestrian 22 activates motion detector 9 first by walking under or in very close proximity to detector 9 beam signalling system controller 8 which inturn actuates visual and audible warning 16 instantly signalling pedestrian 23, visually and audibly, to take caution for someone is entering the doorway at same approximate moment, thereby avoiding possible conflict within the doorway. Situation would reverse itself if pedestrian 23 had reached detector 11 first then detector 11 would signal controller 8 which inturn actuates visual and audible warning 17 instantly signalling pedestrian 22, visually and audibly, to take caution for someone is exiting through the doorway from room C at same approximate moment thereby avoiding possible conflict within doorway.

Drawing 5, utilizes same corridor layout only this situation corner D is depicted as pedestrians 24 and 25 approach corner D. Pedestrian 25 has just actuated beam of detector 13 activating system controller 8 which inturn actuates visual and audible warning device 18 instantly warning pedestrian 24 to use caution before rounding corner D because pedestrian 25 is about to round corner D at same approximate momemt thereby avoiding possible conflict between pedestrians 24 and 25. If pedestrian 24 had actuated the beam of detector 12 first, then pedestrian 25 would get the visual and audible warnings 19 to use caution pedestrian 24 is about to round corner D.

The above drawings are utilized to show simple operation of the claimed warning system and is no limited in design to illustrations shown. The embodiment design utilized for this application shows modular components remote of each other and of the system controller. This same said system can be combined into a single housing unit for monitoring a single corner of any design where intersecting traffic lanes or corridors present hazzards to pedistrians and/or equipment operated by individuals utilizing same said traffic flow lanes.

I claim;

1. A collision avoidance warning system, consisting of at least one electronic system module, at least two infrared motion detection devices, at least two visual warning devices, and at least two audible warning devices, for providing advance visual and audible warning to pedestrians and/or people operating equipment to prevent and avoid collisions as same said meet and/or cross paths at corners and/or other areas of pedestrian traffic with limited lines of sight of said pedestrians creates potential hazzards for collision events within and/or outside building structures.

2. A warning system according to claim 1, having an system control module that can control multiple pedestrian conflict areas from a single location adjacent to said areas.

3. A warning system according to claim 1, having at least two infrared motion detection devices for monitoring specific directional motion of pedestrian and/or equipment traffic movement.

4. A warning system according to claim 1, having at least two visual warning devices of which each specific visual warning responds to signals initiated by said specific corresponding motion detector.

5. A warning system according to claim 1, having at least two audible warning devices of which each specific audible warning responding to signals initiated by said specific corresponding motion detector.

6. A warning system control module according to claim 2, will control system operations for said multiple pedestrian traffic conflict areas and warn each said area, visually and audibly, independently of one another.

7. A warning system according to claim 1, operates on low voltage Direct Current for minimal energy consumption.

8. A warning system according to claim 7, operating at low voltage DC allows for safer and simpler installations due to less stringent municipal wiring code requirements.

9. A warning system controller according to claim 6, will operate said warning system for said multiple conflict areas and provide said warnings independently of one another, requiring no devices to be worn by pedestrians and/or affixed to or on top of equipment operated by individuals to facilitate the operation of said system.

10. A warning system according to claim 1, will provide said operation either with said components remote from one another or combined into a single housing and function as claimed.
